(19) United States
(12) Patent Application Publication
(10) Pub. No.: US 2021/0301226 A1
(43) Pub. Date: Sep. 30, 2021

(54) GEL-FORM CLEANING AGENT COMPOSITION AND CLEANING AGENT PRODUCT

(71) Applicant: DAIO PAPER CORPORATION, Shikokuchuo-shi, Ehime (JP)

(72) Inventor: Kosuke YAMAZAKI, Shikokuchuo-shi (JP)

(73) Assignee: DAIO PAPER CORPORATION, Shikokuchuo-shi, Ehime (JP)

(21) Appl. No.: 17/265,310

(22) PCT Filed: Sep. 17, 2019
(86) PCT No.: PCT/JP2019/036287

§ 371 Date: Feb. 2, 2021

(30) Foreign Application Priority Data
Sep. 28, 2018 (JP) 2018-183235

(51) Int. Cl. C11D 17/00; C11D 11/00; C11D 17/04; C11D 3/22; C11D 3/50

(52) U.S. Cl. CPC C11D 17/003; C11D 11/0023; C11D 3/50; C11D 3/222; C11D 17/041

(57) ABSTRACT

A gel-form cleaning agent composition contains cellulose nanofibers, cyclodextrin, a surfactant, and water. Preferably, the contained amount of the cellulose nanofibers is 0.01-0.1 mass % and the contained amount of the cyclodextrin is 0.1-0.5 mass %. As a result, it is possible to provide a gel-form cleaning agent composition and a cleaning agent product, which enable a user to visually confirm the advantageous effect, easily.

### TECHNICAL FIELD

The present invention relates to a gel-form cleaning agent composition and a cleaning agent product.

### BACKGROUND ART

A variety of cleaning agents are conventionally used to clean dirt adhering to a toilet bowl, etc. which is periodically flushed with water. Among such cleaning agents is known a gel-form cleaning agent which, in order to exert its cleaning effect over a long period of time, is attached e.g. to the inner surface of a toilet bowl so that the agent will be gradually dissolved in flushing water (see, for example, patent literatures 1 and 2).

### CITATION LIST

### Patent Literature

Patent literature 1: Japanese Patent No. 5697124

Patent literature 2: Japanese Patent No. 6141501

### SUMMARY OF THE INVENTION

### Problems to be Solved by the Invention

In the case of such a gel-form cleaning agent which, when used, is attached e.g. to the inner surface of a toilet bowl, a cleaning effect is produced through gradual dissolution of the cleaning agent in flushing water. Such a cleaning agent has the problem that a user hardly perceives the dissolution of the cleaning agent, and therefore it is difficult for the user to confirm whether a cleaning effect is actually produced.

It is therefore an object of the present invention to provide a gel-form cleaning agent composition and a cleaning agent product which enable a user to visually confirm the cleaning effect with ease.

### Means for Solving the Problems

In order to achieve the object, the present invention, in preferred embodiments, provides the following:

An embodiment as described in claim 1 relates to a gel-form cleaning agent composition comprising cellulose nanofibers, a cyclodextrin, a surfactant, and water.

According to this embodiment, it is possible to provide a gel-form cleaning agent composition which foams well during use and which enables a user to visually confirm the cleaning effect with ease.

An embodiment as described in claim 2 relates to the gel-form cleaning agent composition according to claim 1, wherein the cellulose nanofibers are contained in an amount of not less than 0.01% by mass and not more than 0.1% by mass.

According to this embodiment, the foaming of the gel-form cleaning agent composition can be further improved.

An embodiment as described in claim 3 relates to the gel-form cleaning agent composition according to claim 1 or 2, wherein the cyclodextrin is contained in an amount of not less than 0.1% by mass and not more than 0.5% by mass.

According to this embodiment, the foaming of the gel-form cleaning agent composition can be further improved.

An embodiment as described in claim 4 relates to the gel-form cleaning agent composition according to any one of claims 1 to 3, wherein the cellulose nanofibers have an average fiber width of not less than 1 nm and not more than 100 nm.

According to this embodiment, the foaming of the gel-form cleaning agent composition can be further improved.

An embodiment as described in claim 5 relates to the gel-form cleaning agent composition according to any one of claims 1 to 4, further comprising a perfume.

According to this embodiment, the gel-form cleaning agent composition can have a fragrance effect over a long period of time.

An embodiment as described in claim 6 relates to a cleaning agent product comprising: a push-out container; and the gel-form cleaning agent composition according to any one of claims 1 to 5, stored in the push-out container.

According to this embodiment, it is possible to provide a cleaning agent product storing a gel-form cleaning agent composition which foams well during use and which enables a user to visually confirm the cleaning effect with ease.

### Advantageous Effects of the Invention

According to the present invention, it is possible to provide a gel-form cleaning agent composition and a cleaning agent product which enable a user to visually confirm the cleaning effect with ease.

### BRIEF DESCRIPTION OF THE DRAWINGS

FIG. 1 is a perspective view showing an example of a push-out container which is used to attach a gel-form cleaning agent, composed of a gel-form cleaning agent composition according to an embodiment, e.g. to the inner surface of a toilet bowl.

FIG. 2 is a cross-sectional view on line II-II of FIG. 1.

FIG. 3A is a perspective view showing a gel-form cleaning agent which has been pushed out of the push-out container shown in FIG. 1 and attached e.g. to the inner surface of a toilet bowl.

FIG. 3B is a cross-sectional view on line b-b of FIG. 3A.

FIG. 4 is a side view of a push-out container according to a variation, of which depiction of part of the container body is omitted.

FIG. 5 is a plan view of the push-out container according to the variation.

### DESCRIPTION OF EMBODIMENTS

A gel-form cleaning agent composition according to an embodiment of the present invention will now be described in detail.

### [Gel-Form Cleaning Agent Composition]

The gel-form cleaning agent composition according to this embodiment has a gel-like form, and comprises cellulose nanofibers (hereinafter referred to as “CNF”), and a cyclodextrin.

As used herein, “gel-form” refers to a state which is not a sol but a shape-retaining semisolid at 25° C.

### (CNF)

CNF refers to fine cellulose fibers obtained by defiberizing pulp fibers, in particular to fine cellulose fibers generally having a nanometer-size average fiber width (not less than 1 nm and not more than 1000 nm).

Examples of pulp fibers usable for the production of CNF include chemical pulps such as hardwood pulp (e.g. LBKP) and softwood pulp (e.g. NBKP); mechanical pulps such as bleached thermomechanical pulp (BTMP), stone ground pulp (SGP), pressurized stone ground pulp (PGW), refiner ground pulp (RGP), chemi-ground pulp (CGP), thermo-ground pulp (TGP), ground pulp (GP), thermomechanical pulp (TMP), chemi-thermomechanical pulp (CTMP), and refiner mechanical pulp (RMP); recycled pulps produced from waste kraft paper, waste kraft envelopes, waste magazines, waste newspaper, waste flier paper, waste office paper, waste corrugated board, waste high-quality white paper, waste Kent paper, waste chemical pulp paper, waste low-grade paper, and waste coarse paper; and deinked pulp (DIP) produced by subjecting recycled pulp to a deinking treatment. These pulps may be used singly or in a combination of two or more as long as the advantageous effects of the present invention are not impaired.

Methods for producing CNF include, and are not limited to, a mechanical method such as a high-pressure homogenization method, a microfluidization method, a grinding method, a beads-mill freeze milling method, an ultrasonic defibration method, etc.

For example, after performing a defibration treatment of pulp fibers by a mechanical method, the pulp fibers may be subjected to a chemical treatment such as carboxymethylation, or an enzymatic treatment. Chemically-treated CNF can be exemplified by iCNP (individualized CNF) (single nanocellulose fibers) having a diameter of 3 to 4 nm, such as TEMPO-oxidized CNF, phosphoric acid-esterified CNF, or phosphorus acid-esterified CNF.

Alternatively, after performing a chemical treatment or an enzymatic treatment of CNF, the CNF may be subjected to a defibration treatment by a mechanical method.

CNF for use in this embodiment preferably has an average fiber width, calculated by the below-described method, of 1 nm to 100 nm.

The content of CNF in the gel-form cleaning agent composition is preferably not less than 0.002% by mass and not more than 0.2% by mass. Thus, for example, when CNF is mixed with water and used in the form of a slurry having a concentration of 2% mass, the slurry is to be used preferably in an amount of not less than 0.1% by mass and not more than 10% by mass. The use of CNF in an amount of less than 0.002% by mass does not sufficiently exert the below-described effect of improving foaming. The use of CNF in an amount of more than 0.2% by mass causes considerable foaming upon stirring during the production of the cleaning agent, making the production difficult. The content of CNF is more preferably not less than 0.01% by mass and not more than 0.1% by mass.

A specific example of usable CNF is CNF composed of 100% NBKP and having an average fiber width (median value) of 49 nm. The CNF can be obtained by roughly defibrating NBKP with a refiner, and then performing defibration of the refined pulp with a high-pressure homogenizer four times.

A method for measuring the fiber width (average fiber width) of CNF will now be described.

First, 100 ml of an aqueous dispersion of cellulose nanofibers having a solid content concentration of 0.01 to 0.1% by mass is filtered with a TEFLON (registered trademark) membrane filter, and subjected to solvent replacement, once with 100 ml of ethanol and three times with 20 ml of t-butanol.

Next, the resulting CNF are freeze-dried and coated with osmium to prepare a sample. The sample is observed with an SEM image with an electronic microscope at a magnification of 5,000 times, 10,000 times or 30,000 times (at a magnification of 30,000 times for the CNF described in paragraph 0021) depending on the widths of the fibers. In particular, two diagonal lines are drawn on the SEM image, and three straight lines passing through the intersection of the diagonal lines are arbitrarily drawn. The widths of a total of 100 fibers intersecting the three straight lines are visually measured. The median value of the measured values is defined as the average fiber width. Instead of the median value of the measured values, the number average value or the mode value may be used as the average fiber width.

### (Cyclodextrin)

The content of the cyclodextrin in the gel-form cleaning agent composition is preferably not less than 0.1% by mass and not more than 0.5% by mass. The use of the cyclodextrin in an amount of less than 0.1% by mass does not sufficiently exert the below-described effect of improving foaming. The use of the cyclodextrin in an amount of more than 0.5% by mass achieves the effect of improving foaming. Unfavorably, however, the cyclodextrin will be hardly dissolved in water, making it difficult to produce a transparent gel.

There is no particular limitation on the type of the cyclodextrin; any of α-cyclodextrin, β-cyclodextrin and γ-cyclodextrin can be used.

### (Other Components)

Besides CNF and the cyclodextrin, the gel-form cleaning agent composition may contain a surfactant, a perfume, glycerin, water, etc. Among them, a surfactant and water are essential components.

The surfactant and water are essential to produce the cleaning agent in the form of a gel. A non-ionic surfactant such as an ester-type or ether-type surfactant, or an alkyl glycoside can be used as the surfactant.

For example, a polyoxyalkylene alkyl ether, which is a non-ionic surfactant, can be used as the surfactant. The content of the surfactant is preferably not less than 1% by mass and not more than 70% by mass.

As illustrated in the below-described Examples, the effects of the present invention can be achieved both when the concentration of the non-ionic surfactant is as low as less than 10% by mass and when the concentration of the non-ionic surfactant is as high as more than 50% by mass.

The perfume is used to impart a fragrance effect to the gel-form cleaning agent composition in addition to the cleaning effect.

There is no particular limitation on the type of the perfume; for example, a citrus perfume, a rose perfume, or a floral perfume may be used.

The content of the perfume is preferably not less than 0.5% by mass and not more than 10% by mass. When the content is less than 0.5% by mass, the fragrance effect is often insufficient. When the content exceeds 10% by mass, the cleaning agent composition may hardly gelate.

Glycerin is used to control the gelation concentration of the gel-form cleaning agent composition.

The content of glycerin is preferably not less than 3% by mass and not more than 20% by mass.

### [Effects of the Gel-Form Cleaning Agent Composition]

Because of the large surface area of CNF, the nanofibers act as a steric barrier, thus contributing to improvement in foaming. The cyclodextrin encapsulates and covers a hydrophobic substance that hinders foaming, and therefore has the effect of reducing an adverse effect of an oil component, such as the perfume, of the gel-form cleaning agent composition on foaming. Accordingly, by adding CNF and the cyclodextrin to the gel-form cleaning agent composition, it becomes possible to improve foaming that occurs when the gel-form cleaning agent dissolves in water.

Thus, when the gel-form cleaning agent is attached e.g. to the inner surface of a toilet bowl and used, it foams well when it dissolves in flushing water. Therefore, a user can visually confirm with ease whether the effect of the cleaning agent is produced.

In addition, the enhancement of foaming can enhance the cleaning effect.

Further, the cyclodextrin, when used with the perfume, encapsulates the perfume such that it will be released upon contact of the cyclodextrin with water. Therefore, the concomitant use of the perfume and the cyclodextrin enables the perfume to be hardly released until the gel-form cleaning agent is dissolved in water, thus making it possible to increase the duration of the fragrance effect of the gel-form cleaning agent.

In order to efficiently produce such effects, the perfume is preferably mixed with the cyclodextrin in advance so that the perfume in the mixed state is added to the gel-form cleaning agent composition.

CNF have high thixotropic properties. Thus, the viscosity of the gel-form cleaning agent composition is likely to decrease when it is subjected to a shear stress, while the viscosity of the gel-form cleaning agent composition is likely to increase when it remains stationary.

Accordingly, the viscosity of the gel-form cleaning agent composition decreases when the user applies a force to it in order to push it out of a container. This facilitates the operation of pushing the gel-form cleaning agent composition out of the container. The viscosity of the gel-form cleaning agent composition increases after attaching it e.g. to the inner surface of a toilet bowl, whereby the gel-form cleaning agent composition becomes firmly fixed thereto. This enables the gel-form cleaning agent to exert the cleaning effect over a long period of time.

### [Variation]

The gel-form cleaning agent composition may further contain carboxymethyl cellulose (hereinafter referred to as “CMC”).

CMC binds to OH groups of CNF and, through an electrostatic interaction and steric hindrance, promotes separation between molecules. Thus, CMC can prevent agglomeration of CNF, thereby enhancing their effects.

When the gel-form cleaning agent composition contains CMC, the content of CMC is preferably not less than 0.5% by mass and not more than 10% by mass. When the content is less than 0.5% by mass, the above effect cannot be fully exerted. When the content exceeds 10% by mass, the gelation of the composition will be unstable; it will be difficult for the composition to maintain the form of a gel. The content of CMC is most preferably not less than 1% by mass and not more than 5% by mass.

The gel-form cleaning agent composition may also contain hydroxyethyl cellulose (hereinafter referred to as “HEC”). HEC can achieve the same effect as CMC.

When the gel-form cleaning agent composition contains HEC, the content of HEC is preferably not less than 0.5% by mass and not more than 10% by mass. When the content is less than 0.5% by mass, the above effect cannot be fully exerted. When the content exceeds 10% by mass, the gelation of the composition will be unstable; it will be difficult for the composition to maintain the form of a gel. The content of HEC is most preferably not less than 1% by mass and not more than 5% by mass.

The gel-form cleaning agent composition of this embodiment is not necessarily used on the inner surface of a toilet bowl, and may be used widely at places where water is to be flushed periodically, for example, a sink.

### [Description of Push-Out Container]

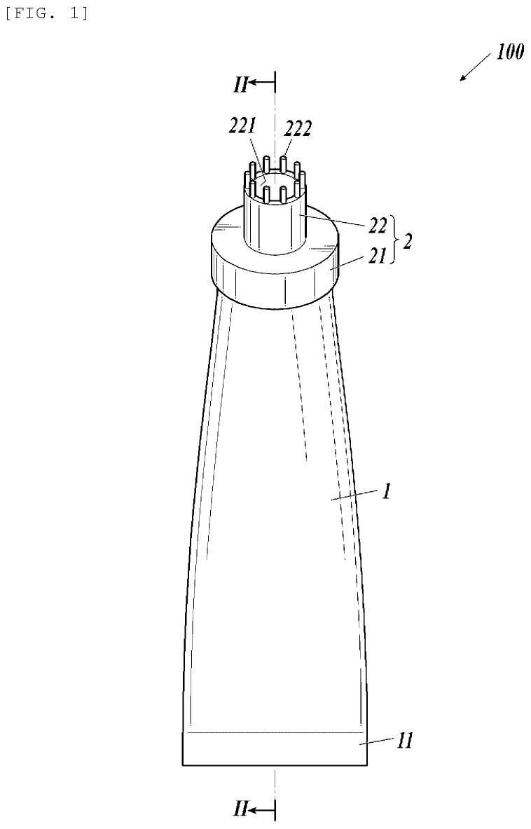

A push-out container 100 to be used for attaching a gel-form cleaning agent W, composed of the gel-form cleaning agent composition of this embodiment, e.g. to the inner surface of a toilet bowl will now be described with reference to FIGS. 1 through 3B. It is to be noted that the push-out container 100 is merely an example. A container having any other appropriate shape may be used to attach the gel-form cleaning agent W, composed of the gel-form cleaning agent composition of this embodiment, e.g. to the inner surface of a toilet bowl.

### {Construction of the Push-Out Container}

As shown in FIG. 1, the push-out container 100 includes a container body 1 and a discharge portion 2.

### (Container Body)

The container body 1 is a member constituting the main body of the push-out container 100 and which internally has a hollow storage space S to be filled with the gel-form cleaning agent W.

As shown in FIGS. 1 and 2, a flattened end portion 11 is formed by fusion at one end of the container body 1. As shown in FIG. 2, a generally circular opening, a body-side opening 12, is formed at the other end of the container body 1.

As shown in FIG. 2, the outer periphery of the container body 1, located around the body-side opening 12, has a circular shape having approximately the same diameter as the below-described discharge portion-side opening 211 of the discharge portion 2. The container body 1 is inserted into the discharge portion-side opening 211, and the container body 1 and the discharge portion 2 are connected by any method, e.g. by adhesion with an adhesive.

To the contrary, the outer periphery of the discharge portion 2, located around the below-described discharge portion-side opening 211, may have a circular shape having approximately the same diameter as the body-side opening 12, and the container body 1 and the discharge portion 2 may be connected such that the discharge portion 2 is inserted into the body-side opening 12. In order to prevent the discharge portion 2 from separating from the container body 1 when pushing out the gel-form cleaning agent W, the container body 1 and the discharge portion 2 are preferably connected in the manner shown in FIG. 2.

The container body 1 is formed of a material which is softer than that of the discharge portion 2. The hardness of the material, as measured by JIS K 6253 (type-A durometer), is preferably 70 to 90.

Examples of usable materials include polyethylene terephthalate (PET), polypropylene (PP), aluminum, and various types of vapor-deposited films.

The size of the container body 1 may be arbitrarily determined depending on the amount of the gel-form cleaning agent W to be filled into the container body 1. However, from the viewpoint of securing a sufficient internal volume that allows for multi-time use and ensuring convenience for attaching the gel-form cleaning agent W to the inner surface of a toilet bowl, the container body 1 preferably has a diameter of 5 mm to 30 mm in an area around the body-side opening 12, a length of 50 mm to 150 mm from the flattened end portion 11 to the body-side opening 12, and an internal volume of 30 ml to 100 ml.

### (Discharge Portion)

The discharge portion 2 has an opening through which the gel-form cleaning agent W is pushed out and, as shown in FIGS. 1 and 2, includes a connecting portion 21 and a projecting portion 22.

The discharge portion 2 is formed of a material which is harder than that of the container body 1. The hardness of the material, as measured by JIS K 6253 (type-A durometer), is preferably 90 to 100.

Examples of usable materials include PET, PP, etc.

### (Connecting Portion)

As shown in FIGS. 1 and 2, a generally circular opening, a discharge portion-side opening 211, is formed at one end of the connecting portion 21.

As shown in FIG. 2, the outer periphery of the container body 1, located around the body-side opening 12, has a circular shape having approximately the same diameter as the discharge portion-side opening 211 of the discharge portion 2. The container body 1 is inserted into the discharge portion-side opening 211, and the container body 1 and the discharge portion 2 are connected by any method, e.g. by adhesion with an adhesive.

To the contrary, the outer periphery of the discharge portion 2, located around the discharge portion-side opening 211, may have a circular shape having approximately the same diameter as the body-side opening 12, and the container body 1 and the discharge portion 2 may be connected such that the discharge portion 2 is inserted into the body-side opening 12. In order to prevent the discharge portion 2 from separating from the container body 1 when pushing out the gel-form cleaning agent W, the container body 1 and the discharge portion 2 are preferably connected in the manner shown in FIG. 2.

As shown in FIG. 2, the surface of the connecting portion 21, facing the discharge portion-side opening 211, has a central opening which connects with the projecting portion 22.

The connecting portion 21 is formed in a cylindrical shape having a diameter which is slightly larger than the diameter of the container body 1 in its area around the body-side opening 12, and having a height of 10 mm to 30 mm.

### (Projecting Portion)

As shown in FIG. 2, the projecting portion 22 is formed in a cylindrical shape and connected to the opening formed in the surface of the connecting portion 21 on the side opposite to the side connected to the container body 1, and is connected to the storage space S of the container body 1 via the connecting portion 21. The gel-form cleaning agent W in the storage space S can therefore be pushed out through the interiors of the connecting portion 21 and the projecting portion 22.

A circular discharge outlet 221, through which the gel-form cleaning agent W is pushed out, is formed at the front end of the projecting portion 22. Further, a plurality of protrusions 222 are formed at the front end of the projecting portion 22 such that they circumferentially surround the discharge outlet 221. While FIG. 1 illustrates the formation of 10 protrusions 222, the number of protrusions 222 is not limited to 10. The provision of the protrusions 222 enables the gel-form cleaning agent W to be attached to a target surface, such as the inner surface of a toilet bowl, in a uniform shape and, in addition, can prevent the gel-form cleaning agent W from adhering to the front end of the projecting portion 22.

To be able to easily push out the gel-form cleaning agent Wand to press the gel-form cleaning agent W of an appropriate size against the inner surface of a toilet bowl, as described below, the discharge outlet 221 of the projecting portion 22 preferably has a diameter of 10 mm to 25 mm, more preferably 15 mm to 20 mm.

In order to secure an appropriate distance from the container body 1 to the inner surface of a toilet bowl when pressing the gel-form cleaning agent W against the inner surface of the toilet bowl, thereby facilitating the pressing operation, as described below, the length of the projecting portion 22 except the protrusions 222 is preferably 5 mm to 30 mm, more preferably 10 mm to 20 mm.

In order to adequately produce the above effects, the protrusions 222 preferably protrude 0.5 mm to 5 mm, more preferably 1 mm to 3 mm from the area around the discharge outlet 221. In order to prevent the gel-form cleaning agent W from adhering to the front end of the projecting portion 22, the protrusions 222 are preferably arranged at intervals of at least 1 mm.

Preferably, all the protrusions 222 have the same length, and their tops lie in the same plane.

### {Method for Using the Push-Out Container}

When using the push-out container 100, the user first grips the container body 1, and presses on it to push the gel-form cleaning agent W in the storage space S out of the front end of the projecting portion 22. The user adjusts the push-out amount according to the intended amount of the gel-form cleaning agent W to be attached e.g. to the inner surface of a toilet bowl.

Subsequently, the user brings the projecting portion 22 of the push-out container 100, with a portion of the gel-form cleaning agent W having been pushed out, close to a spot, e.g. on the inner surface of a toilet bowl, to which the gel-form cleaning agent W is intended to be attached, and presses the portion of the gel-form cleaning agent W, lying outside the push-out container 100, against the spot. By pressing the gel-form cleaning agent W while turning the push-out container 100, the gel-form cleaning agent W spreads uniformly around the projecting portion 22.

The attachment of the gel-form cleaning agent W should be performed while avoiding direct contact of the projecting portion 22 with the inner surface of the toilet bowl.

Subsequently, the user pulls the push-out container 100 away from the inner surface of the toilet bowl. The portion of the gel-form cleaning agent W, lying outside the push-out container 100, adheres to and remains on the inner surface of the toilet bowl.

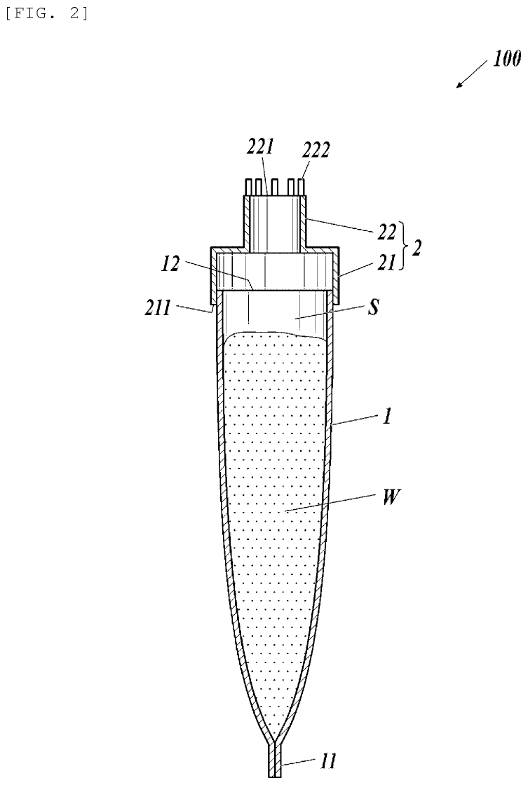

The gel-form cleaning agent W has spread uniformly around the projecting portion 22 as described above. A large amount of the gel-form cleaning agent W adheres to an area that has been located outside the projecting portion 22, while a small amount of the gel-form cleaning agent W adheres to an area that has overlapped the projecting portion 22. Thus, the gel-form cleaning agent W, adhering to the inner surface of the toilet bowl, has a shape having a concave portion in a central area as shown in FIGS. 3A and 3B.

### {Effects of the Push-Out Container}

The use of the push-out container 100 can attach the gel-form cleaning agent W e.g. to the inner surface of a toilet bowl in such a manner that the attached gel-form cleaning agent W has a shape as shown in FIGS. 3A and 3B.

A cleaning agent, adhering e.g. to the inner surface of a toilet bowl, gradually dissolves in flushing water. When the cleaning agent remains on the toilet bowl for a long period of time without being subjected to water flushing e.g. due to no use of the toilet, then the surface of the cleaning agent will dry. If the cleaning agent dries up and becomes hardened, the cleaning agent may not be dissolved in flushing water any more, resulting in a loss of the cleaning effect.

In this regard, according to the push-out container 100, the gel-form cleaning agent W can be attached e.g. to the inner surface of a toilet bowl in such a manner that the attached gel-form cleaning agent W has a shape having a central concave portion as described above. Water is likely to be collected in the concave portion, thus making it possible to prevent drying of the attached gel-form cleaning agent W.

The use of the push-out container 100 can attach the gel-form cleaning agent W e.g. to the inner surface of a toilet bowl simply by pushing out the gel-form cleaning agent W, and pressing it against the inner surface of the toilet bowl, as described above. The push-out container 100 can thus facilitate the operation of attaching the gel-form cleaning agent W e.g. to the inner surface of a toilet bowl.

When the gel-form cleaning agent W is attached e.g. to the inner surface of a toilet bowl by means of the push-out container 100, the gel-form cleaning agent W is pressed against the inner surface of the toilet bowl. This enables the gel-form cleaning agent W to hardly peel off the surface just after it is attached to it. Further, the gel-form cleaning agent W can be securely attached even to a curved surface.

The use of the push-out container 100 can attach the gel-form cleaning agent W e.g. to the inner surface of a toilet bowl without direct contact of the discharge portion 2 with the surface. This is advantageous from a hygiene viewpoint.

The push-out container 100 can discharge the gel-form cleaning agent W in any amount. The amount of the gel-form cleaning agent W, to be attached e.g. to the inner surface of a toilet bowl, can therefore be adjusted depending on, for example, the intended duration of the cleaning effect.

According to the push-out container 100, the gel-form cleaning agent W is stored in the relatively soft container body 1. Therefore, the gel-form cleaning agent W can be pushed out while deforming the container body 1. This can reduce the amount of the gel-form cleaning agent W that remains in the container and cannot be discharged and used.

### {Variation of the Push-Out Container}

The shape or construction of the front end of the projecting portion 22 of the discharge portion 2 is not limited to the protrusions 222. However, it is preferred to use a shape having a plurality of spaces formed in the circumferential direction. In order to prevent the gel-form cleaning agent W from adhering to the front end of the projecting portion 22, each of the spaces preferably has a circumferential width of not less than 1 mm.

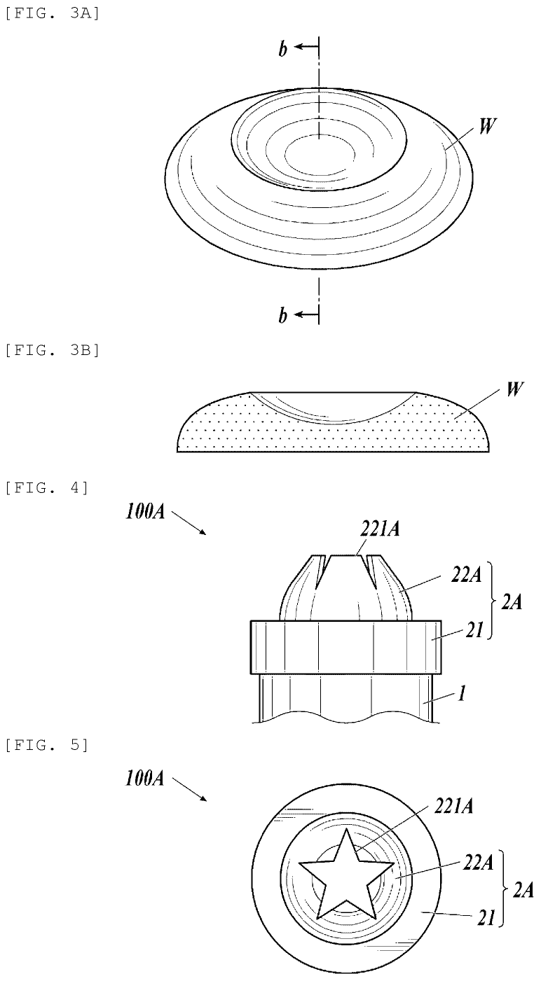

The shape of the projecting portion 22 is not limited to a cylindrical shape as shown in FIGS. 1 and 2. For example, it is possible to use the projecting portion 22A shown in FIGS. 4 and 5, which has a generally hemispherical shape and has a discharge outlet 221A at the front end. While FIGS. 4 and 5 illustrate the discharge outlet 221A which is star-shaped in a plan view, the discharge outlet 221A is not limited to such a shape. As shown in FIGS. 4 and 5, from the viewpoint of stably holding the gel-form cleaning agent W that has been pushed out, the top of the area around the discharge outlet 221A is preferably plane-shaped.

### Examples

An evaluation of foaming upon dissolution in water was made for gel-form cleaning agent compositions of Examples and Comparative Examples.

### [Compositions of Examples and Comparative Examples]

Gel-form cleaning agent compositions of Examples and Comparative Examples, having the components and their contents described in Table 1, were prepared.

In the compositions of the Examples and Comparative Examples described in Table 1, the following products were used as the components.

PC-2465 (manufactured by Miyoshi Oil & Fat Co., Ltd.) was used as the polyoxyalkylene alkyl ether.

HITENOL 227L (manufactured by DKS Co., Ltd.) was used as the sodium polyoxyethylene lauryl ether sulfate.

PC-2850 (manufactured by Miyoshi Oil & Fat Co., Ltd.) was used as the polyoxyethylene alkyl ether.

The CNF described in paragraphs 0021 and 0022 was used as the cellulose nanofibers. The CNF were mixed with water and used in the form of a 2 mass % aqueous slurry.

CAVAMAX W6 Food (α-cyclodextrin, CycroChem Co., Ltd.) was used as the cyclodextrin.

CLEAN FLORAL (manufactured by Sakae Aromatic Co., Ltd.) was used as the perfume.

Microcare MTO (Thor Japan Co., Ltd.) was used as the DPG/MIT (methylisothiazolinone)/IPBC mixture.

### [Test Method]

For each of the gel-form cleaning agent compositions of the Examples and Comparative Examples, measurement of the height of bubbles generated was performed by the following method.

(1) 6 g of a gel-form cleaning agent, corresponding to one-time usage, was attached to a plastic board in such a manner that in a plan view, the attached gel-form cleaning agent had a generally rectangular shape whose long sides were each about 40-mm long and whose short sides were each about 20-mm long.
(2) 500 ml of tap water (18° C.) was poured on the attached gel-form cleaning agent in three equally divided amounts.
(3) All the tap water that had been poured on the gel-form cleaning agent was recovered and put into a cylinder for a permeation method (the outer diameter 90 mm, the inner diameter 75 mm, the height of the internal space 515 mm).
(4) The cylinder holding the recovered tap water was rotated 180 degrees from its upright position (in which the height direction of the cylinder coincides with the vertical direction) so that it was vertically reversed, and then the cylinder was rotated −180 degrees so that it was retuned to the original position. The above operation was performed three times at a rotational speed of 180 degrees per second. Thereafter, the height of bubbles generated (the vertical height of bubbles generated on the surface of water in the cylinder) was measured just after and 5 minutes after completion of the cylinder-rotating operation.

### [Test Results]

The test results are shown in Table I below.

TABLE I

| | | Ex. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|
| | | 1 | 2 | 3 | 4 | 5 | 6 | 7 | 8 | 9 | 10 | 11 | 12 | 13 |
| Content | Purified water | 41.3 | 40.9 | 40.4 | 39.4 | 36.4 | 31.4 | 39.6 | 39.2 | 38.7 | 58.3 | 57.9 | 57.4 | 56.4 |
| (mass %) | Polyoxyalkylene | 51.0 | 51.0 | 51.0 | 51.0 | 51.0 | 51.0 | 51.0 | 51.0 | 51.0 | 9.0 | 9.0 | 9.0 | 9.0 |
| | alkyl ether | | | | | | | | | | | | | |
| | Sodium | 5.0 | 5.0 | 5.0 | 5.0 | 5.0 | 5.0 | 5.0 | 5.0 | 5.0 | 5.0 | 5.0 | 5.0 | 5.0 |
| | polyoxyethylene | | | | | | | | | | | | | |
| | lauryl ether | | | | | | | | | | | | | |
| | sulfate | | | | | | | | | | | | | |
| | Polyoxyethylene | 0.0 | 0.0 | 0.0 | 0.0 | 0.0 | 0.0 | 0.0 | 0.0 | 0.0 | 25.0 | 25.0 | 25.0 | 25.0 |
| | alkyl ether | | | | | | | | | | | | | |
| | 2% cellulose | 0.1 | 0.5 | 1.0 | 2.0 | 5.0 | 10.0 | 2.0 | 2.0 | 2.0 | 0.1 | 0.5 | 1.0 | 2.0 |
| | nanofiber | | | | | | | | | | | | | |
| | slurry | | | | | | | | | | | | | |
| | Cyclodextrin | 0.3 | 0.3 | 0.3 | 0.3 | 0.3 | 0.3 | 0.1 | 0.5 | 1.0 | 0.3 | 0.3 | 0.3 | 0.3 |
| | Perfume | 2.0 | 2.0 | 2.0 | 2.0 | 2.0 | 2.0 | 2.0 | 2.0 | 2.0 | 2.0 | 2.0 | 2.0 | 2.0 |
| | DPG/MIT | 0.3 | 0.3 | 0.3 | 0.3 | 0.3 | 0.3 | 0.3 | 0.3 | 0.3 | 0.3 | 0.3 | 0.3 | 0.3 |
| | (methyliso- | | | | | | | | | | | | | |
| | thiazolinone)/ | | | | | | | | | | | | | |
| | IPBC mixture | | | | | | | | | | | | | |
| Height | just after | 36 | 38 | 41 | 45 | 51 | 51 | 44 | 44 | 44 | 29 | 32 | 34 | 36 |
| of | 5 min after | 19 | 21 | 25 | 27 | 29 | 29 | 28 | 28 | 28 | 16 | 17 | 20 | 23 |
| bubbles | | | | | | | | | | | | | | |
| (mm) | | | | | | | | | | | | | | |
| | | | | Ex. | Ex. | Comp. | Comp. | Comp. | Comp. | Comp. | Comp. | Comp. | Comp. | Comp. |
| | | | | 14 | 15 | Ex. 1 | Ex. 2 | Ex. 3 | Ex. 4 | Ex. 5 | Ex. 6 | Ex. 7 | Ex. 8 | Ex. 9 |

| | | | | | | | | | | | | |
|---|---|---|---|---|---|---|---|---|---|---|---|---|
| Content | Purified water | 53.4 | 48.4 | 41.4 | 41.7 | 41.6 | 41.2 | 40.7 | 39.7 | 36.7 | 31.7 | 58.4 |
| (mass %) | Polyoxyalkylene | 9.0 | 9.0 | 51.0 | 51.0 | 51.0 | 51.0 | 51.0 | 51.0 | 51.0 | 51.0 | 9.0 |
| | alkyl ether | | | | | | | | | | | |
| | Sodium | 5.0 | 5.0 | 5.0 | 5.0 | 5.0 | 5.0 | 5.0 | 5.0 | 5.0 | 5.0 | 5.0 |
| | polyoxyethylene | | | | | | | | | | | |
| | lauryl ether | | | | | | | | | | | |
| | sulfate | | | | | | | | | | | |
| | Polyoxyethylene | 25.0 | 25.0 | 0.0 | 0.0 | 0.0 | 0.0 | 0.0 | 0.0 | 0.0 | 0.0 | 25.0 |
| | alkyl ether | | | | | | | | | | | |
| | 2% cellulose | 5.0 | 10.0 | 0.0 | 0.0 | 0.1 | 0.5 | 1.0 | 2.0 | 5.0 | 10.0 | 0.0 |
| | nanofiber | | | | | | | | | | | |
| | slurry | | | | | | | | | | | |
| | Cyclodextrin | 0.3 | 0.3 | 0.3 | 0.0 | 0.0 | 0.0 | 0.0 | 0.0 | 0.0 | 0.0 | 0.3 |
| | Perfume | 2.0 | 2.0 | 2.0 | 2.0 | 2.0 | 2.0 | 2.0 | 2.0 | 2.0 | 2.0 | 2.0 |
| | DPG/MIT | 0.3 | 0.3 | 0.3 | 0.3 | 0.3 | 0.3 | 0.3 | 0.3 | 0.3 | 0.3 | 0.3 |
| | (methyliso- | | | | | | | | | | | |
| | thiazolinone)/ | | | | | | | | | | | |
| | IPBC mixture | | | | | | | | | | | |
| Height | just after | 42 | 43 | 36 | 35 | 35 | 37 | 40 | 43 | 44 | 47 | 30 |
| of | 5 min after | 24 | 24 | 16 | 14 | 17 | 20 | 22 | 25 | 25 | 25 | 13 |
| bubbles | | | | | | | | | | | | |
| (mm) | | | | | | | | | | | | |

In Examples 6 and 15 and Comparative Example 8, in which the content of the 2 mass % slurry was 10% by mass (the content of CNF was 0.2% by mass), the cleaning agent compositions were likely to foam during their production.

In Example 9 in which the content of the cyclodextrin was 1.0% by mass, the cyclodextrin was hardly dissolved in water.

### [Evaluation]

Compared to Comparative Example 2 in which no CNF nor cyclodextrin was used, the height of bubbles was higher both just after and 5 minutes after completion of the cylinder-rotating operation in Examples 1 to 9 in which the CNF and the cyclodextrin were used, and the contents of the other components were the same as those of Example 2. This indicates that the use of CNF and cyclodextrin in a gel-form cleaning agent composition can enhance foaming of the composition and increase the durability of the bubbles generated.

As is apparent from comparison of an Examples with a Comparative Example which use the same content of CNF and which differ in the presence/absence of the cyclodextrin (Example 1 vs. Comparative Example 3, Example 2 vs. Comparative Example 4, Example 3 vs. Comparative Example 5, Example 4 vs. Comparative Example 6, Example 5 vs. Comparative Example 7, and Example 6 vs. Comparative Example 8), the height of bubbles was higher both just after and 5 minutes after completion of the cylinder-rotating operation in the Examples in which both the CNF and the cyclodextrin were used than in the Comparative Examples in which only the CNF was used. This indicates that compared to the sole use of CNF, the concomitant use of CNF and cyclodextrin can enhance foaming of the gel-form cleaning agent composition and increase the durability of the bubbles generated.

As can be seen from comparison of Examples 10 to 15 with Comparative Example 9 which all use the polyoxyalkylene alkyl ether, which is a non-ionic surfactant, at a low content of 9.0% by mass, the height of bubbles was, inmost cases, higher both just after and 5 minutes after completion of the cylinder-rotating operation in Examples 10 to 15 in which both the CNF and the cyclodextrin were used than in Comparative Example 9 in which no CNF was used. The test data thus verifies that both when the content of the polyoxyalkylene alkyl ether, which is a non-ionic surfactant and serves as a gelation component, is as high as more than 50% by mass and when the content is as low as less than 10% by mass, the combined use of CNF and cyclodextrin can enhance foaming of the gel-form cleaning agent composition and increase the durability of the bubbles generated.

As will be appreciated from comparison of Examples 2 to 5 with Examples 1 and 6, and comparison of Examples 11 to 14 with Examples 10 and 15, the content of the 2 mass % slurry is especially preferably not less than 0.5% by mass and not more than 5% by mass, i.e. the content of CNF is especially preferably not less than 0.01% by mass and not more than 0.1% by mass. In particular, when the content of the 2 mass % slurry is 0.1% by mass (the content of CNF is 0.002% by mass), the effect produced is low or insufficient. On the other hand, when the content of the 2 mass % slurry is 10% by mass (the content of CNF is 0.2% by mass), there is no significant difference in the effect from the case of using the 2 mass % slurry in an amount of 5% by mass (0.1% by mass of CNF). In addition, when the content of the 2 mass % slurry exceeds 5% by mass, bubbles are likely to be generated during the production of the gel-form cleaning agent, which is undesirable. When the content of the 2 mass % slurry exceeds 10% by mass (the content of CNF exceeds 0.2% by mass), the production of a transparent gel becomes difficult due to the influence of bubbles.

Comparison between Examples 4, 7, 8 and 9 verifies that the content of the cyclodextrin is preferably not less than 0.1% by mass and not more than 0.5% by mass. In particular, the gel-form cleaning agent of Example 7, having a cyclodextrin content of 0.1% by mass, has a foaming effect which is appreciably enhanced as compared to the gel-form cleaning agent of Comparative Example 6 having the same content of CNF but containing no cyclodextrin. On the other hand, the data for the above Examples indicates no significant enhancement in the foaming effect with the increase in the content of the cyclodextrin from 0.1% by mass. Furthermore, in Example 9 in which the content of the cyclodextrin was 0.1% by mass, the cyclodextrin was hardly dissolved in water, and it was difficult to produce a transparent gel.

### INDUSTRIAL APPLICABILITY

The present invention can be advantageously applied in the field of production of gel-form cleaning agent compositions and cleaning agent products.

### DESCRIPTION OF THE SYMBOLS

100, 100A push-out container
1 container body
11 flattened end portion
12 body-side opening
2, 2A discharge portion
21 connecting portion
211 discharge portion-side opening
22, 22A projecting portion
221, 221A discharge outlet
222 protrusion
W gel-form cleaning agent
S storage space

1-6. (canceled)

7. A gel-form cleaning agent composition comprising:
cellulose nanofibers, a cyclodextrin, a surfactant, and water.

8. The gel-form cleaning agent composition according to claim 7, wherein the cellulose nanofibers are contained in an amount of not less than 0.01% by mass and not more than 0.1% by mass.

9. The gel-form cleaning agent composition according to claim 7, wherein the cyclodextrin is contained in an amount of not less than 0.1% by mass and not more than 0.5% by mass.

10. The gel-form cleaning agent composition according to claim 7, wherein the cellulose nanofibers have an average fiber width of not less than 1 nm and not more than 100 nm.

11. The gel-form cleaning agent composition according to claim 7, further comprising a perfume.

12. A cleaning agent product comprising: a push-out container; and the gel-form cleaning agent composition according to claim 7, stored in the push-out container.
